(19) United States
(12) Patent Application Publication
(10) Pub. No.: US 2024/0097103 A1
(43) Pub. Date: Mar. 21, 2024

(54) SURFACE-MODIFIED COMPOSITE ZINC-BASED NEGATIVE ELECTRODE AND PREPARATION METHOD THEREOF, AND BATTERY

(71) Applicant: Zhejiang University, Hangzhou (CN)

(72) Inventors: Huilin Pan, Hangzhou (CN); Ning Dong, Hangzhou (CN); Ziyang Cai, Hangzhou (CN)

(21) Appl. No.: 18/317,572

(22) Filed: May 15, 2023

(30) Foreign Application Priority Data
Sep. 20, 2022 (CN) 2022111448904

(51) Int. Cl. H01M 4/134; H01M 4/1395; H01M 4/62; H01M 10/38

(52) U.S. Cl. CPC H01M 4/134; H01M 4/1395; H01M 4/623; H01M 4/626; H01M 10/38; H01M 2004/027

(57) ABSTRACT

A surface-modified composite zinc-based negative electrode, a preparation method thereof, and a battery are provided. The composite zinc-based negative electrode includes a zinc matrix material, a nano inorganic metal/alloy modified layer, and an organic polymer protective layer. The nano inorganic metal/alloy modified layer can increase hydrogen evolution overpotential of the composite zinc-based negative electrode, inhibit the generation of hydrogen on the negative electrode surface and occurrence of side reactions. The organic polymer protective layer can enhance the zinc ion concentration and deposition uniformity at the electrode interface, and improve the dendrite problem caused by uneven zinc deposition-dissolution during the charging and discharging process. The application of the modified composite zinc-based negative electrode in aqueous zinc-based batteries can improve their cycling stability under high current and high utilization conditions and show good rate performance and cycling life. The method has simple preparation process, low cost, and is suitable for large-scale production.

### TECHNICAL FIELD

The disclosure relates to the field of aqueous zinc-based batteries, and more particularly to a surface-modified composite zinc-based negative electrode and a preparation method thereof, and a battery.

### BACKGROUND

At present, lithium-ion batteries occupy a dominant position in electrochemical energy storage technology. However, commercial lithium-ion batteries are mainly based on organic electrolyte systems, which have potential safety hazards such as high toxicity and easy combustion. In recent years, aqueous zinc-based batteries have attracted wide attention due to their advantages such as low cost, high energy density, good safety, and environmental friendliness. However, it is still a great challenge to improve the electrochemical performance of zinc negative electrode (also referred to as zinc cathode) in practical applications.

Metal zinc negative electrode has problems such as low coulombic efficiency, insufficient utilization, and zinc dendrite growth. Specifically, the low coulombic efficiency and insufficient utilization are mainly related to the hydrogen evolution reaction and the generation of irreversible by-products of the zinc negative electrode, and zinc dendrites are mainly caused by the uneven zinc deposition-dissolution process. In response to the above issues, researchers at home and abroad have proposed many effective measures, including the structure design of a three-dimensional electrode or a current collector (e.g., published in CN113782702A, CN114171726A), electrolyte additives (e.g., published in CN114725536A, CN114843626A), construction of surface protection layers (e.g., published in CN114725336A, CN114335447A), etc., all of which have solved the electrode-electrolyte interfacial instability to a certain extent and improved the cycle life of aqueous batteries. However, the complex preparation process, high cost, and limited cycle life under high surface capacity and high current conditions limit the practical application of many methods. Therefore, developing zinc negative electrode materials with excellent cycling stability and high specific capacity under high current and high surface capacity conditions, simple preparation method, and low cost is of great significance for promoting the practical application of aqueous zinc-based batteries.

### SUMMARY

The disclosure proposes a surface-modified composite zinc-based negative electrode which has a simple preparation process and is suitable for large-scale production. The composite zinc-based negative electrode includes a zinc matrix material, a nano inorganic metal/alloy modified layer, and an organic polymer protective layer. Through the synergistic effect of the nano inorganic metal/alloy layer and the organic polymer protective layer, the problems of hydrogen evolution, by-product accumulation and dendrite caused by uneven deposition/stripping of zinc on a surface of the negative electrode are simultaneously relieved, the cycle stability and the discharge specific capacity of an aqueous zinc-based battery under conditions of large current and high zinc utilization rate are improved, and the cycle life of the battery is prolonged.

Technical solutions adopted by the disclosure are as follows.

Specifically, a surface-modified composite zinc-based negative electrode is provided, including a zinc matrix material, a nano inorganic metal/alloy modified layer, and an organic polymer protective layer. The zinc matrix material can be at least one of a metal zinc foil, zinc powder, and a zinc-based alloy.

In an embodiment, the nano inorganic metal/alloy modified layer is formed in situ on the zinc matrix material by placing the zinc matrix material in an aqueous reaction solution containing an inorganic salt and a buffer through a chemical displacement reaction. The inorganic salt in the reaction solution is at least one of indium chloride, indium nitrate, indium sulfate, antimony chloride, antimony fluoride, tin chloride, tin fluoride, lead nitrate, lead acetate, and lead chloride. The buffer is at least one of thiourea, sodium citrate, citric acid, and boric acid.

In an embodiment, a concentration of the inorganic salt in the reaction solution is in a range of 1 gram per liter (g/L) to 50 g/L, a concentration of the buffer is 0.1 to 3 times the concentration of the inorganic salt, and reaction time is in a range of 1 second to 1 hour. The reaction time is specifically adjusted according to the concentration of the reaction solution.

In an embodiment, the organic polymer protective layer is obtained by drying the matrix coated with a polymer modified layer paste. The modified layer paste is a mixture of the following components and a solvent, and mass proportions of respective components in the paste are: 1-95 wt % polymer powder, 0-20 wt % binder, 0-20 wt % functional electrolyte salt, 0-5 wt % functional filler, and the remaining amount is the solvent. The total proportion of the respective components and the solvent is 100%.

In an embodiment, the solvent in the polymer modified layer paste is at least one or a mixture of deionized water, acetonitrile, and N-methylpyrrolidone. The polymer powder is at least one of polyacrylamide, polypyrrole, polyvinylidene fluoride, and 2-methylimidazole zinc salt. The binder is at least one of polyvinylidene fluoride, carboxymethyl cellulose, styrene butadiene rubber, polyvinyl alcohol, and polyvinyl butyral. The functional electrolyte salt is at least one of lithium bis(trifluoromethanesulfonyl)imide (LiTFSI), lithium bis(fluorosulfonyl)imide (LiFSI), lithium trifluoromethane sulfonate (LiTfO), zinc sulfate (ZnSO₄), zinc bis(trifluoromethanesulfonyl)imide (Zn(TFSI)₂), zinc trifluoromethylsulfonate (Zn(TfO)₂), sodium(I) Bis(trifluoromethanesulfonyl)imide (NaTFSI), sodium (I) bis(fluorosulfonyl)imide (NaFSI), and sodium trifluoromethylsulfonate (NaTfO). The functional filler in the polymer modified layer paste is at least one of alumina, zinc oxide, magnesium oxide, titanium oxide, silicon oxide, and zirconia. The polymer modified layer paste is prepared by mixing the respective components with the solvent, with a mixing time in a range of 0.1-12 hours, and the reaction temperature is in a range of 25-100 Celsius degree (° C.).

In an embodiment, a thickness of the organic polymer protective layer is in a range of 2 nanometers (nm) to 200 micrometers (μm). The preferred thickness of the organic polymer protective layer is in a range of 200 nm to 2 μm.

A battery adopts the surface-modified composite zinc-based negative electrode as the negative electrode, and the battery is one of an aqueous zinc-based battery, a zinc air battery, and a zinc-based liquid flow battery.

According to an embodiment of the disclosure, the preparation process of the surface-modified composite zinc-based negative electrode includes the following steps.

Step (1), the zinc matrix material is a zinc foil or a sheet-like zinc alloy material, the zinc matrix material is scrubbed by ethanol for multiple times to remove impurities on the surface of the zinc matrix material. The inorganic salt and the buffer are weighed according to the concentration ratio, stirred and dissolved in deionized water. The wiped clean foil-like zinc matrix material is soaked in a reaction solution containing the inorganic salt and the buffer. After a uniform layer of inorganic metal/alloy is formed on the surface of the zinc matrix material in situ, take it out, clean it multiple times with deionized water, and perform low temperature drying at a temperature in a range of room temperature to 60° C. in a vacuum oven.

Step (2), the polymer powder, the binder, the functional electrolyte salt, and the functional filler are weighed according to the mass ratio, and stirred in an oil bath at a temperature in a range of 25-100° C. for 0.1-12 hours to dissolve them in the solvent. The foil-like matrix prepared in the step (1) is coated with the polymer paste, dried in a vacuum oven at a temperature in a range of room temperature to 60° C., and a foil-like organic/inorganic surface-modified composite zinc-based negative electrode is prepared after removing the solvent.

According to another embodiment of the disclosure, the preparation process of the surface-modified composite zinc-based negative electrode includes the following steps.

Step (a) the zinc matrix material is zinc powder or powdery zinc alloy material, and the inorganic salt and the buffer are weighed according to the concentration ratio, stirred and dissolved in deionized water. Under a protective atmosphere, the powdery zinc matrix material is added to the aqueous reaction solution and slowly stirred for reaction. After a uniform inorganic metal/alloy layer is formed on the surface of the zinc matrix material in situ, the reacted powdery matrix is obtained by filtration or suction filtration, and the reacted powdery matrix is washed several times with deionized water and dried at a temperature in a range of room temperature to 60° C. in a vacuum oven. The powder-like matrix, the binder, and the conductive agent modified with inorganic metal/alloy layer are weighed according to a certain mass ratio, dissolved in a solvent, and coated on the surface of a stainless steel mesh or a carbon paper to prepare a matrix in a form of pole piece modified with inorganic metal/alloy layer. Alternatively, the powdery zinc matrix material, the binder, and the conductive agent are first weighed according to the mass ratio and dissolved in a solvent, coated on the surface of the stainless steel mesh or the carbon paper to prepare a zinc matrix material in a form of pole piece. Then, the zinc matrix material in the form of pole piece is soaked in a reaction solution containing the inorganic salt and the buffer, reacted for a period of time, washed several times with deionized water, and dried in a vacuum oven at a temperature in a range of room temperature to 60° C. to obtain an inorganic metal/alloy layer modified matrix in a form of pole piece.

Step (b), the polymer powder, the binder, the functional electrolyte salt, and the functional filler are weighed according to the mass ratio, and stirred in an oil bath at a temperature in arrange of 25-100° C. for 0.1-12 hours to dissolve them in the solvent. The inorganic metal/alloy layer modified matrix in a form of pole piece prepared in the step (a) is coated with polymer paste, dried in a vacuum oven at a temperature in a range of room temperature to 60° C., and a composite zinc-based negative electrode with organic/inorganic surface modification after removing the solvent is prepared.

The modified composite zinc-based negative electrode described in the disclosure mainly has the following advantages compared to the related art.

On the one hand, the inorganic metal/alloy modified layer on the surface of the composite zinc-based negative electrode can greatly increase the hydrogen overpotential of the composite zinc-based negative electrode, reduce the generation of hydrogen gas at the interface and the occurrence of side reactions during battery cycling, and the nano-porous structure of the inorganic modified layer is conducive to achieving uniform and rapid zinc ion transmission at the interface of the negative electrode interface. On the other hand, the organic polymer protective layer has a strong interaction with zinc ions, which can enhance the zinc ion concentration and deposition uniformity at the electrode interface, improve the ion migration rate and inhibit the growth of zinc dendrites. The synergistic effect between the organic/inorganic composite modified layers can simultaneously solve the main problems existing in the metal zinc negative electrode, significantly improving the long cycle stability of the aqueous zinc-based battery under high current density and high utilization conditions. In addition, the preparation method provided by the disclosure has simple operation, mild and fast reaction conditions, low raw material cost, and is suitable for large-scale production.

### BRIEF DESCRIPTION OF DRAWINGS

FIG. 1 illustrates a schematic structural diagram of a composite zinc-based negative electrode according to the disclosure.

FIG. 2A illustrates a surface scanning electron microscopy (SEM) diagram of a composite zinc-based negative electrode according to embodiment 1 of the disclosure.

FIGS. 2B-2D illustrate energy dispersive spectroscopy (EDS) diagrams of respective elements of the composite zinc-based negative electrode according to the embodiment 1 of the disclosure.

FIG. 3A illustrates a surface SEM diagram of a composite zinc-based negative electrode according to embodiment 3 of the disclosure.

FIGS. 3B-3C illustrate EDS diagrams of respective elements of the composite zinc-based negative electrode according to the embodiment 3 of the disclosure.

FIG. 4 illustrates a linear scanning curve diagram of the composite zinc-based negative electrode prepared in the embodiment 1 and a pure zinc negative electrode in comparative embodiment 1 by linear scan voltammetry (LSV) according to embodiment 2 of the disclosure.

FIG. 5 illustrates voltage-time curves of a symmetric battery with the composite zinc-based negative electrodes prepared in the embodiment 1 and symmetric batteries with composite zinc-based negative electrodes in comparative embodiments 1-6 under test conditions of 5 milliamperes per square centimeter (mA/cm²) and 5 milliamp hour per square centimeter (mAh/cm²) (zinc utilization rate: 28.5%) according to the embodiment 2 of the disclosure.

FIG. 6 illustrates voltage-time curves of the symmetric battery with the composite zinc-based negative electrodes prepared in the embodiment 1 and the symmetric battery with pure zinc negative electrodes in the comparative embodiment 1 under test conditions of 10 mA/cm² and 10 mAh/cm² (zinc utilization rate: 57%) according to the embodiment 2 of the disclosure.

FIG. 7 illustrates voltage-time curves of a symmetric battery with composite zinc-based negative electrodes prepared in embodiment 3 of the disclosure and a symmetrical battery with pure zinc powder negative electrodes in comparative embodiment 7 under test conditions of 1 mA/cm² and 1 mAh/cm² (zinc utilization rate: 11.4%).

FIG. 8 illustrates the voltage-time curve of a symmetrical battery with composite zinc-based negative electrodes under test conditions of 10 mA/cm² and 10 mAh/cm² (zinc utilization rate: 57%) according to embodiment 5 of the disclosure.

FIG. 9 illustrates the voltage-time curve of a symmetrical battery with composite zinc-based negative electrodes under test conditions of 10 mA/cm² and 10 mAh/cm² (zinc utilization rate: 57%) according to embodiment 6 of the disclosure.

FIG. 10 illustrates curves of coulombic efficiency, specific capacity, and cycling performance of the composite zinc-based negative electrode prepared in the embodiment 1 and a full battery assembled with the pure zinc negative electrode and an electrolytic manganese dioxide positive electrode at a rate of 5 C according to the embodiment 2 of the disclosure.

FIG. 11 illustrates curves of coulombic efficiency, specific capacity, and cycling performance of a full battery assembled with the composite zinc-based negative electrode prepared in the embodiment 1 and an electrolytic manganese dioxide positive electrode at a negative/positive electrode capacity ratio (N/P ratio) of 3.8 and a rate of 0.1 C according to the embodiment 2 of the disclosure.

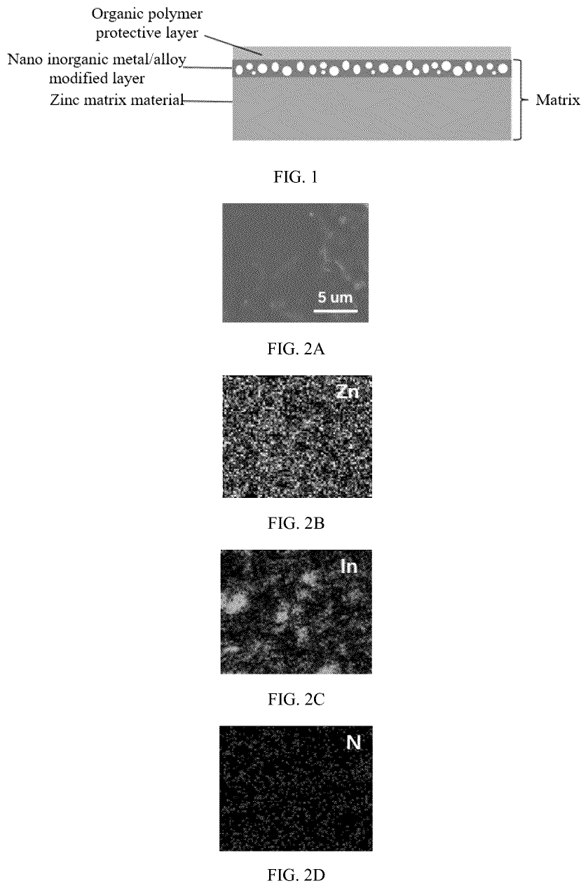

### DETAILED DESCRIPTION OF EMBODIMENTS

The disclosure will be further described in detail with reference to the accompanying drawings and specific embodiments, but the embodiments of the disclosure are not limited thereto.

### Embodiment 1

A surface-modified foil-like composite zinc-based negative electrode is provided, the preparation process of which includes the following steps.

Step (1), 0.4 grams (g) of indium chloride (InCl₃) and 1.2 g of thiourea are weighed and dissolved in 20 milliliters (mL) of deionized water to obtain an aqueous reaction solution as an indium containing reaction solution. A commercial zinc foil is scrubbed several times with ethanol to remove impurities on a surface of the zinc foil. The scrubbed zinc foil is soaked in the indium containing reaction solution mentioned above, the soaked zinc foil is taken out after reacting for 10 seconds, the reacted zinc soil is washed several times with deionized water, and the washed zinc foil is performed low temperature drying in a vacuum oven at 40° C. for about 3 hours, so as to obtain a foil-like zinc-indium matrix.

Step (2), 0.25 g of polyacrylamide (PAM, molecular weight abbreviated as Mw: 2-14 million grams per mole abbreviated as g/mol) and 0.1 g of zinc sulfate (ZnSO₄) electrolyte salt are weighed and added to 10 mL of deionized water, and stirred in an oil bath at 50° C. for 3 hours to form a uniform and transparent polymer paste.

Step (3), the polymer paste is evenly dispersed on a surface of the foil-like zinc-indium matrix obtained in the step (1) by using a doctor blade coating method or a spin coating method, the solvent is removed by performing low temperature drying at 50° C. for about 5 hours in a vacuum oven, and a thin and uniform polymer film is formed on the surface of the zinc-indium matrix to obtain a composite zinc-based negative electrode with organic/inorganic surface modification. After surface modification, the electrode is cut into a circular pole piece with a diameter of 15 millimeters (mm), denoted as ZnIn-PAM.

Step (4), the morphology observation and element analysis are performed on a surface of the ZnIn-PAM negative electrode prepared in the step (3) by using a scanning electron microscope. As shown in FIGS. 2A-2D, the organic polymer modified layer and the inorganic metal indium layer are uniformly distributed on the surface of the zinc foil matrix material.

### Comparative Embodiment 1

A commercial zinc foil is scrubbed with ethanol several times to remove impurities on a surface of the zinc foil. The processed zinc foil is cut into a circular pole piece with a diameter of 15 mm as a pure zinc metal negative electrode.

### Comparative Embodiment 2

The zinc foil modified with inorganic metal indium layer is prepared using the same method as the step (1) in the embodiment 1, so as to obtain a treated composite zinc negative electrode. The treated composite zinc negative electrode is cut into a circular pole piece with a diameter of 15 mm, which is used as a composite zinc-based negative electrode modified only with a nano inorganic metal indium layer.

### Comparative Embodiment 3

A zinc foil coated with a PAM polymer protective layer is prepared by using the same method as the steps (2) and (3) in the embodiment 1, so as to obtain a treated composite zinc negative electrode. The treated composite zinc negative electrode is cut into a circular pole piece with a diameter of 15 mm as a composite zinc-based negative electrode modified only with an organic polymer protective layer.

### Comparative Embodiment 4

A composite zinc-based negative electrode is prepared using the similar method as in the embodiment 1, with the difference being that in the step (1), the aqueous reaction solution used to prepare a nano inorganic modified layer is prepared by dissolving 0.4 g of antimonic fluoride (SbF₃) and 1.2 g of sodium citrate in 20 mL of deionized water. The treated composite zinc negative electrode is cut into a circular pole piece with a diameter of 15 mm, which is used as an inorganic metal antimony/organic polymer surface-modified composite zinc-based negative electrode (also referred to as a composite zinc-based negative electrode with inorganic metal antimony and organic polymer surface modification).

### Comparative Embodiment 5

A composite zinc-based negative electrode is prepared using the similar method as in the embodiment 1, with the difference being that in the step (1), the aqueous reaction solution used to prepare a nano inorganic modified layer is prepared by dissolving 0.4 g of stannic chloride (SnCl₂, also referred to as tin chloride) and 1.2 g of sodium citrate in 20 mL of deionized water. The treated composite zinc negative electrode is cut into a circular pole piece with a diameter of 15 mm, which is used as an inorganic metal tin/organic polymer surface-modified composite zinc-based negative electrode (also referred to as a composite zinc-based negative electrode with inorganic metal tin and organic polymer surface modification).

### Comparative Embodiment 6

A composite zinc-based negative electrode is prepared using the similar method as in the embodiment 1, with the difference being that in the step (1), a nano inorganic indium modified layer is deposited on the surface of zinc foil by magnetron sputtering for 10 seconds to 5 minutes, and the treated composite zinc anode is cut into a circular pole piece with a diameter of 15 mm, which is used as an inorganic indium/organic polymer surface-modified composite zinc-based negative electrode with by magnetron sputtering (also referred to as a composite zinc-based negative electrode with inorganic indium and organic polymer surface modification).

### Embodiment 2

Performance testing, including the following steps.

Step (1), the surface-modified composite zinc-based negative electrode prepared in the embodiment 1 and the pure zinc foil negative electrode (i.e., the pure zinc metal negative electrode) in the comparative embodiment 1 are taken as the working electrode, a stainless steel mesh is taken as a counter electrode, and Ag/AgCl is taken as a reference electrode, the linear sweep voltammetry is run in 1 mole per liter (mol/L) sodium sulfate (Na₂SO₄) electrolyte at a sweep rate of 5 millivolts per second (mV/s). As shown in FIG. 4, the hydrogen evolution potential of the surface-modified composite zinc-based negative electrode is much higher than that of the pure zinc negative electrode.

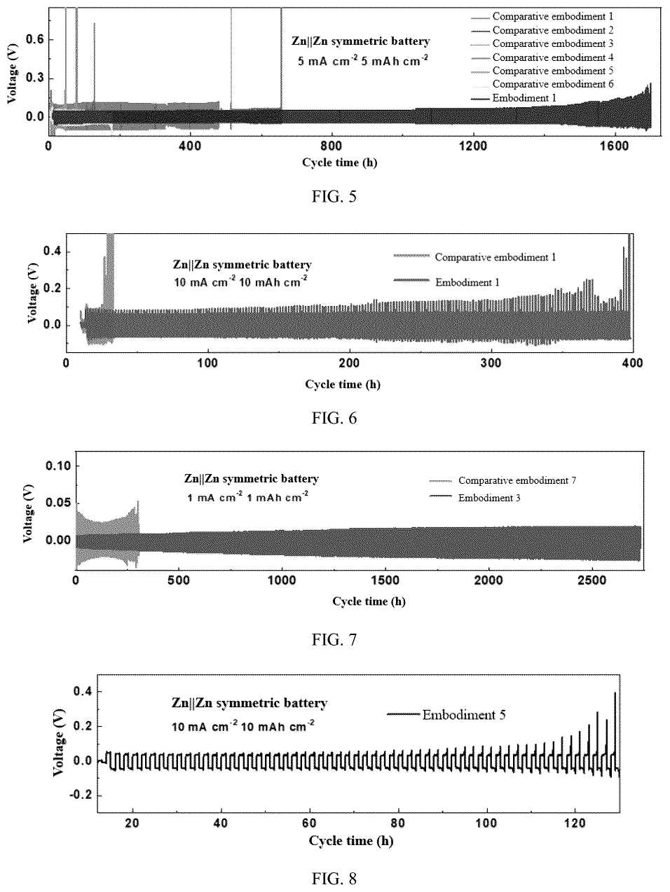

Step (2), the composite zinc-based negative electrodes prepared in the embodiment 1 and the comparative embodiments 1 to 6 are respectively assembled into symmetric batteries, and CR2032 button batteries are respectively assembled with 1 mol/L zinc sulfate (ZnSO₄) electrolyte and microfiber glass separator for cyclic charge-discharge test. The long cycle performance of the symmetric batteries is tested at current densities and surface capacities of 5 milliamperes per square centimeter (mA/cm²), 5 milliamp hour per square centimeter (mAh/cm²), and 10 mA/cm², 10 mAh/cm², respectively. As shown in FIG. 5 and FIG. 6, the surface modification method of the composite zinc-based negative electrode in the embodiment 1 can more effectively improve the cycle life of the zinc negative electrode under high current and high zinc utilization compared to the composite zinc-based negative electrode prepared using different components and modification methods in the comparative embodiments 1-6.

Step (3), the surface-modified composite zinc-based negative electrode prepared in the embodiment 1 and the pure zinc negative electrode in the comparative embodiment 1 are respectively assembled into full batteries with electrolytic manganese dioxide as the positive electrode, and 2 mol/L ZnSO₄+0.1 mol/L MnSO₄ electrolyte and microfiber glass separator are used to assemble CR2032 button batteries for cyclic charge-discharge test. The long cycle stability of two kinds of full batteries is tested at a rate of 5 C, as shown in FIG. 10, the surface-modified composite zinc-based negative electrode shows a higher discharge specific capacity than the pure zinc negative electrode, and can still maintain a high capacity retention rate after 10000 cycles. In addition, the discharge specific capacity and cycle stability of the full battery with the composite zinc-based negative electrode in the embodiment 1 as the negative electrode are tested under the condition of capacity matching between positive and negative electrodes (negative/positive electrode capacity ratio: 3.8). As shown in FIG. 11, the modified full battery can reach a specific capacity of 250 milliampere-hours per gram (mAh/g) at a rate of 0.1 C and can stably cycle for about 50 cycles, demonstrating high practical application value.

### Embodiment 3

A surface-modified powdery composite zinc-based negative electrode is provided, the preparation process of which includes the following steps.

Step (1), 0.2 g of InCl₃ and 0.4 g of thiourea are weighed and dissolved in 20 mL of deionized water to a reaction solution. 2 g of pure zinc powder is weighed and added to the above reaction solution and slowly stirred and reacted for 30 seconds in a protective atmosphere, so as to obtain a reacted mixed solution. The reacted mixed solution after the reaction is poured into a vacuum filtration device and filtered to obtain a composite zinc-based powder modified with an inorganic metal indium layer. The composite zinc-based powder modified with an inorganic metal indium layer is washed several times with deionized water, performed with low temperature drying in a vacuum oven at 40° C. for about 3 hours to dry moisture, and then grinded to obtain a powdery zinc-indium matrix.

Step (2), the powdery zinc-indium matrix prepared in the step (1), activated carbon conductive agent, and polyvinylidene fluoride binder are respectively weighed according to a mass ratio of 7:2:1, added to N-methylpyrrolidone (also referred to as NMP, N-Methyl-2-pyrrolidone) solvent, and mixed the above solution evenly by using a mechanical mixing mixer to obtained a mixture. The mixture is coated on a surface of a stainless steel mesh or a titanium mesh, and then dried in an air blast drying box at 60 C° for about 5 hours to remove the solvent to obtain a zinc-indium matrix in a form of pole piece.

Step (3), 0.2 g of polyvinylidene fluoride binder and 0.1 g of ZnSO₄ electrolyte salt are weighed and added to 10 g of N-methylpyrrolidone solvent, and stirred at room temperature for about 10 hours and mixed evenly to a mixed solution. 5 g of polypyrrole is weighed and added to the above mixed solution, and a uniform polymer paste is obtained through grinding.

Step (4), the zinc-indium matrix in the form of pole piece prepared in the step (2) is coated with polymer paste, dry at 60° C. for about 5 hours in a vacuum oven to remove the solvent to form a thin and uniform polymer film, so as to obtain an organic/inorganic surface-modified composite zinc-based negative electrode in a form of pole piece. The processed organic/inorganic surface-modified composite zinc-based negative electrode in the form of pole piece is cut into a circular pole piece with a diameter of 15 mm.

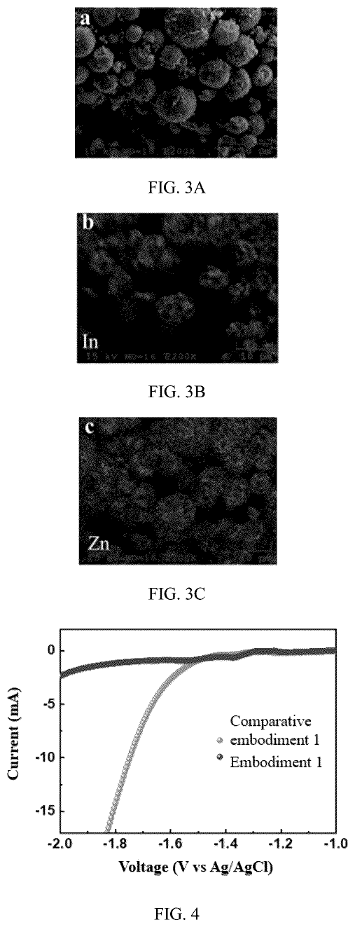

Step (5), the morphology observation and element analysis are performed on a surface of the powdery zinc-indium matrix prepared in the step (1) by using a scanning electron microscope. As shown in FIGS. 3A-3C, the inorganic metal indium layer is uniformly distributed on the surface of the zinc powder particles.

Step (6), symmetric battery assembly and electrochemical performance testing are carried out on the organic/inorganic surface-modified composite zinc-based negative electrode As shown in FIG. 7, the surface-modified composite zinc-based negative electrode can stably cycle for more than 2700 hours under conditions of 1 mA/cm² and 1 mAh/cm², which is more than 9 times that of the pure zinc powder negative electrode. The surface modification method of the powdery metal zinc negative electrode in the embodiment 3 can also effectively improve the long cycle stability of the zinc negative electrode.

### Embodiment 4

The powdery composite zinc-based negative electrode is prepared using the similar method as in the embodiment 3. The difference is that pure zinc powder, activated carbon conductive agent, and polyvinylidene fluoride binder are respectively weighed according to a mass ratio of 7:2:1, added to the N-methylpyrrolidone solvent, and mixed the above solution evenly by using a mechanical mixing mixer to obtained a mixture. The mixture is coated on a surface of a stainless steel mesh or a titanium mesh, and then dried in an air blast drying box at 60 C° for about 5 hours to remove the solvent to obtain a pure zinc powder negative electrode in a form of pole piece. Then, the pure zinc powder negative electrode in the form of the pole piece is soaked in a reaction solution containing indium salt and a buffer. After a period of reaction, the soaked pure zinc powder negative electrode is washed several times with deionized water, and performed with low temperature drying in a vacuum oven at 40° C. for about 3 hours to obtain a zinc-indium matrix in a form of pole piece. The zinc-indium matrix in the form of the pole piece is coated with polymer paste, dried at 60° C. for about 5 hours in a vacuum oven to remove the solvent to thereby form a thin and uniform polymer film, so as to obtain an organic/inorganic surface-modified composite zinc-based negative electrode in a form of pole piece. The treated organic/inorganic surface-modified composite zinc-based negative electrode in the form of pole piece is cut into a circular pole piece with a diameter of 15 mm.

### Comparative Embodiment 7

Zinc powder, activated carbon conductive agent, and polyvinylidene fluoride binder are respectively weighed according to a mass ratio of 7:2:1, added to N-methylpyrrolidone solvent, and mixed the above solution evenly by using a mechanical mixing mixer to obtained a mixture. The mixture is coated on a surface of a stainless steel mesh or a titanium mesh, and then dried in an air blast drying box at 60° C. for about 5 hours to remove the solvent to obtain a product. The product is cut into a circular pole piece with a diameter of 15 mm using a slicer as a pure zinc powder negative electrode.

### Embodiment 5

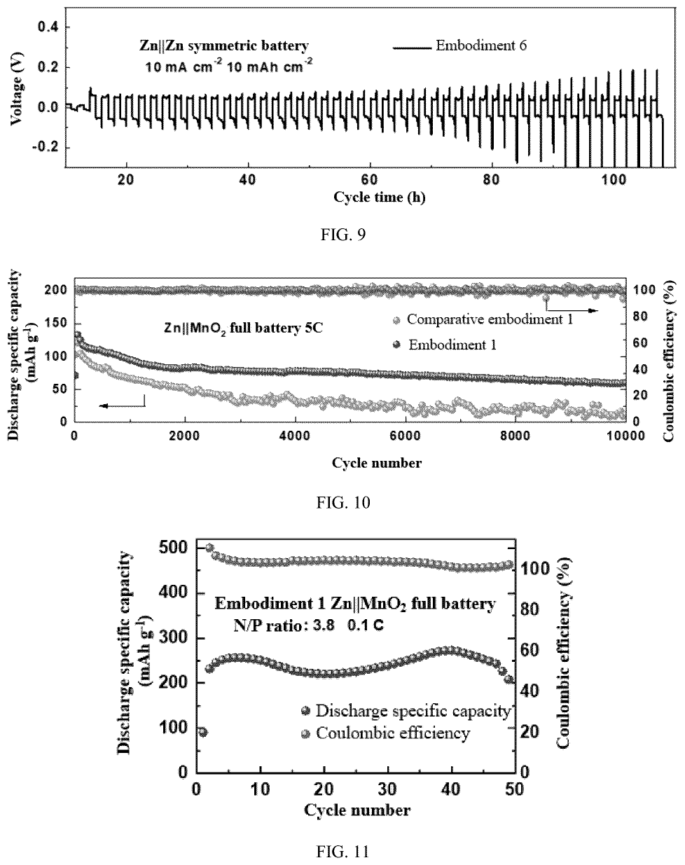

The composite zinc-based negative electrode is prepared using the similar method as in the embodiment 1. The difference is that the polymer paste used to prepare the composite zinc-based negative electrode is formed by mixing N-methylpyrrolidone (NMP):polyvinylidene fluoride (PVDF):lithium bis(trifluoromethanesulfonyl)imide (LiTFSI) by a mass ratio of 10:5:1, and the obtained inorganic/organic surface-modified composite zinc-based negative electrode is denoted as ZnIn-PVDF. The treated composite zinc negative electrode is cut into a circular pole piece with a diameter of 15 mm for symmetric battery assembly and electrochemical testing. As shown in FIG. 8, the surface-modified composite zinc-based negative electrode with different organic polymer components can also extend the cycle life of the zinc negative electrode under high current density and high specific capacity conditions.

### Embodiment 6

The composite zinc-based negative electrode is prepared using the similar method as in the embodiment 1. The difference is that the polymer paste used for preparing the composite zinc-based negative electrode is formed by mixing NMP: 2-methylimidazole zinc salt (ZIF8): PVDF by a mass ratio of 20:4:1. The obtained inorganic/organic surface-modified composite zinc-based negative electrode is denoted as ZnIn—ZIF8, and the treated composite zinc-based negative electrode is cut into a circular pole piece with a diameter of 15 mm for symmetric battery assembly and electrochemical testing. As shown in FIG. 9, the composite zinc-based negative electrode modified with different organic polymer components can also extend the cycle life of the zinc negative electrode under high current density and high specific capacity conditions.

What is claimed is:

1. A surface-modified composite zinc-based negative electrode, comprising: a matrix and an organic polymer protective layer disposed outside the matrix, wherein the matrix comprises a zinc matrix material and one of a nano inorganic metal modified layer and a nano alloy modified layer.

2. The surface-modified composite zinc-based negative electrode according to claim 1, wherein the zinc matrix material is at least one of a metal zinc foil, zinc powder, and a zinc-based alloy.

3. The surface-modified composite zinc-based negative electrode according to claim 1, wherein the one of the nano inorganic metal modified layer and the nano alloy modified layer is formed on the zinc matrix material in situ by placing the zinc matrix material in an aqueous reaction solution containing an inorganic salt and a buffer through a chemical displacement reaction.

4. The surface-modified composite zinc-based negative electrode according to claim 3, wherein when the zinc matrix material is one of a zinc foil and a sheet-like zinc alloy material, the matrix is prepared by: soaking the zinc matrix material in a form of the zinc foil in the aqueous reaction solution, taking out the zinc matrix material after one of an inorganic metal layer and an inorganic alloy layer is generated on a surface of the zinc matrix material in situ, washing the zinc matrix material with the one of the inorganic metal layer and the inorganic alloy layer by using deionized water for a plurality of times, and drying the washed zinc matrix material with the one of the inorganic metal layer and the inorganic alloy layer, so as to obtain the matrix;
wherein when the zinc matrix material is one of zinc powder and a powdery zinc alloy material, the matrix is prepared by: adding the zinc matrix material in a form of powder into the aqueous reaction solution under a protective atmosphere, slowly stirring and reacting for a preset time, filtering or suction filtering to obtain a reacted powdery matrix, washing the reacted powdery matrix with deionized water for a plurality of times, drying, and grinding to obtain a pole piece as the matrix; or the matrix is prepared by: uniformly mixing the zinc matrix material in the form of powder, a binder and a conductive agent into a paste, coating the paste on a surface of a stainless steel mesh or a carbon paper to prepare another pole piece, soaking the prepared pole piece in the aqueous reaction solution, taking out the soaked pole piece after reacting for a predetermined time, washing the reacted pole piece for a plurality of times with deionized water, and drying to obtain the matrix in a form of pole piece.

5. The surface-modified composite zinc-based negative electrode according to claim 3, wherein the inorganic salt in the aqueous reaction solution is at least one of indium chloride, indium nitrate, indium sulfate, antimony chloride, antimonic fluoride, tin chloride, tin fluoride, lead nitrate, lead acetate, and lead chloride, with a concentration in a range of 1 gram per liter (g/L) to 50 g/L.

6. The surface-modified composite zinc-based negative electrode according to claim 3, wherein the buffer in the aqueous reaction solution is at least one of thiourea, sodium citrate, citric acid, and boric acid, and a concentration of the buffer is 0.1-3 times a concentration of the inorganic salt, reaction time is in a range of 1 second to 1 hour, and the reaction time is specifically adjusted according to a concentration of the aqueous reaction solution.

7. The surface-modified composite zinc-based negative electrode according to claim 1, wherein the organic polymer protective layer is obtained by drying the matrix coated with a polymer modified layer paste, the polymer modified layer paste is a mixture of respective components and a solvent, and mass proportions of the respective components in the polymer modified layer paste are: 1-95 wt % polymer powder, 0-20 wt % binder, 0-20 wt % functional electrolyte salt, and 0-5 wt % functional filler, a remaining amount is the solvent, and a total proportion of the respective components and the solvent is 100%.

8. The surface-modified composite zinc-based negative electrode according to claim 7, wherein mixing time of the polymer modified layer paste is in a range of 0.1-12 hours, and reaction temperature is in a range of 25-100 Celsius degree (° C.); a coating method of the polymer modified layer paste comprises a doctor blade method, a spin coating method, a spray drying method and a dipping method; and a thickness of the organic polymer protective layer is in a range of 2 nanometers (nm) to 200 micrometers (μm).

9. The surface-modified composite zinc-based negative electrode according to claim 7, wherein the solvent in the polymer modified layer paste is at least one or a mixture of deionized water, acetonitrile, and N-methylpyrrolidone; the polymer powder is at least one of polyacrylamide, polypyrrole, polyvinylidene fluoride, and 2-methylimidazole zinc salts; the binder is at least one of polyvinylidene fluoride, carboxymethyl cellulose, styrene butadiene rubber, polyvinyl alcohol, and polyvinyl butyral; the functional electrolyte salt is at least one of lithium bis(trifluoromethanesulfonyl)imide (LiTFSI), lithium bis(fluorosulfonyl)imide (LiFSI), lithium trifluoromethane sulfonate (LiTfO), zinc sulfate (ZnSO₄), zinc bis(trifluoromethanesulfonyl)imide (Zn(TFSI)₂), zinc trifluoromethylsulfonate (Zn(TfO)₂), sodium(I) Bis(trifluoromethane sulfonyl)imide (NaTFSI), sodium (I) bis(fluorosulfonyl)imide (NaFSI), and sodium trifluoromethylsulfonate (NaTfO); and the functional filler is at least one of alumina, zinc oxide, magnesium oxide, titanium oxide, silicon oxide, and zirconia.

10. A battery, wherein the battery uses the surface-modified composite zinc-based negative electrode according to claim 1 as a negative electrode, and the battery is one of an aqueous zinc-based battery, a zinc air battery, and a zinc-based liquid flow battery.
